(19) United States
(12) Patent Application Publication
(10) Pub. No.: US 2003/0155037 A1
(43) Pub. Date: Aug. 21, 2003

(54) Wood translocation and splitting apparatus and method of use

(76) Inventor: Barry K. Alexander, Clarkesville, GA (US)

Correspondence Address: Tony D. Alexander, TECHNOLOGY LEGAL COUNSEL LLC, POST OFFICE BOX 1728, EVANS, GA, 30809, US

(21) Appl. No.: 10/283,391

(22) Filed: Oct. 29, 2002

Related U.S. Application Data
(60) Provisional application No. 60/357,732, filed on Feb. 16, 2002.

(51) Int. Cl. B27L 7/00

(52) U.S. Cl. 144/195.1; 144/193.1; 144/366

(57) ABSTRACT

The present invention provides a durable and economical solution to the dilemma facing individuals in the wood processing industry. In particular, a wood translocation and splitting apparatus in accordance with the present invention allows the user to quickly attach the apparatus to an existing and common utility vehicle such as conventional skid steer loaders. Additionally, the apparatus allows for the grasping of wood to be processed, lifting the wood, positioning the wood over a receptacle, splitting the wood and loading the processed wood into the receptacle. Therefore, not only is the user free from having to manually load the apparatus, but they no longer have to manually pick up and load the split wood.

### DOMESTIC PRIORITY

This patent application claims the benefit of priority under 35 U.S.C. § 119 to co-pending U.S. Provisional Application Serial No. 60/357,732, filed Feb. 16, 2002, which is herein incorporated in its entirety by this reference.

### FIELD OF THE INVENTION

The present invention relates generally to cutting tools and an apparatus for lifting and splitting wood in particular.

### BACKGROUND OF THE INVENTION

In the logging industry many tools have been developed to make it easier to process logs once the trees have been cut down. In particular, attempts have been made to provide wood splitting devices that allow on-site processing. Unfortunately, many of these devices have been cumbersome and difficult to get to the work site.

As a result, attempts have been made to provide mobile or compact wood splitting devices. However, this does not address the issue of getting the split wood into the bed of a truck, wheel barrel or other receptacle. In order to address this issue others attempted to affix a wood splitter to the boon of a backhoe. Unfortunately, this adds to the cost of manufacture and creates an additional piece of equipment to introduce to the already cluttered work site. Moreover, it multiplies the number of moving parts that are subject to obsolescence and costly replacement.

An additional limitation of certain devices, including one disclosed in U.S. Pat. No. 6,408,907 to Lantz, is the requirement that in order to utilize the device in the horizontal position, the wood workpiece must first be lifted onto the device. This limits significantly the size of wood that can be processed. Moreover, in order to utilize such systems in the vertical position, the wood workpiece must first be positioned vertically in order to allow the device to adequately access it. Moreover, the length of the piece of wood to be processed must be limited in light of the fact that the vertical orientation of device is a function of the ability of the skid steer loader to lift upward and rotate downward. In other words, the I beam must be shorter than otherwise necessary, in order to use the Lantz device in a vertical orientation, because the skid steer loader mounting plate can only be raised so far and rotated downward so much without exerting too much force on the locking mechanism. Moreover, because of the way the support post 14 and connection members 16 are connected to the common utility plate, the Lantz device would not be balanced or durable enough use in an inverted position. Additionally, the Lantz device has several exposed moving parts, including but not limited to control valves, hydraulic cylinders, etc, which subject the Lantz device to premature obsolescence.

Therefore, there is an existing need for a wood splitting apparatus that is easily and reversibly coupled to an existing utility vehicle such as a skid steer loader, so that multiple separate vehicles are not necessary. In particular, there is a need for an apparatus that is easy to install and remove and is sufficiently portable. Additionally, there is an existing need for such a device to be easily maneuverable so as to grasp, lift and split wood in a simple, straightforward manner. There also remains an existing need for a device that can be used in both a vertical or horizontal position without the need for user intervention to place the wood workpiece on the device. Additionally, there is an existing need for a device that reduces the amount of strain on the mounting mechanism when transitioning the device from the horizontal to vertical position. Moreover, there is a need for a device that allows the wood workpiece to be suspended vertically, allowing the user to manually saw the wood into firewood lengths before splitting. There is also an existing need for a device that is balanced and versatile enough to attach to a farm tractor in an inverted orientation to serve as a conventional wood splitter.

### SUMMARY OF EXEMPLARY EMBODIMENTS

The present inventors have discovered a unique way of addressing all of the above limitations and providing additional advantages. In an exemplary embodiment in accordance with the present invention, a wood translocation and splitting apparatus is provided.

In a preferred embodiment, it is an objective of the invention to provide an apparatus suitably configured to provide a convenient wood processing station at a work site. In the furtherance of this and other objectives, a wood splitter is provided that can be easily coupled with a utility vehicle such as a skid steer loader. In an exemplary embodiment in accordance with the present invention, installation comprises driving the utility vehicle into the receiving end of the wood splitter apparatus and connecting the hydraulic hose thereto. The wood splitting apparatus can be removed just as easily.

Another objective of a preferred embodiment of the present invention is to provide an apparatus for splitting wood workpieces. In one embodiment in accordance with the present invention, the wood workpieces do not have to be manually loaded into the wood splitting apparatus. In fact, it is an objective of this embodiment to provide an apparatus that can grasp wood workpieces that are on the ground and split them.

A principal objective of the present invention is to provide a wood splitting apparatus also suitable for translocating wood workpieces from a work site to a receptacle. In the furtherance of this and other objectives, the wood splitting device also has the capacity to grasp, lift and deposit the split wood pieces into a receptacle. Important to this configuration is the minimization of the number of moving parts required to carry out this function. The objective is to provide a cost-effective solution.

Still another objective of the present invention is to provide an alternative to the current systems that require additional moving parts. In the furtherance of this and other objectives, the wood translocation and splitting apparatus in accordance with an exemplary embodiment of the present invention comprises a support member and wood splitting means coupled with the support member. The support member is operatively coupled with a utility vehicle, such as a skid steer loader, and controlled by the remote hydraulics of the utility vehicle. As a result, the user does not have to purchase an additional wood processing vehicle, but rather a single attachment that can be easily adapted to a utility vehicle already in the fleet.

Yet another objective of a preferred embodiment of the invention is to provide a wood splitting apparatus that is suitable for use with any utility vehicle having remote hydraulic controls.

It is an objective of a preferred embodiment to provide a physically stable apparatus versatile enough for various applications.

Further objectives, features and advantages of the invention will be apparent from the following detailed description taken in conjunction with the accompanying drawings.

### BRIEF DESCRIPTION OF THE DRAWINGS

FIG. 1. An illustration of a front and back perspective view of a wood translocation and splitting apparatus embodying the present invention attached to the front of a tractor.

FIG. 2. An illustration of a rear perspective view of the splitting blades, shown coupled with the apparatus support member.

FIG. 3. An illustration of a side perspective view of a wood translocation and splitting apparatus embodying the present invention, shown in a standard open orientation with respect to the support member.

FIG. 4. An illustration of a side perspective view of a wood translocation and splitting apparatus embodying the present invention, shown in a standard closed orientation with respect to the support member.

FIG. 5. An illustration of a front perspective view of a wood translocation and splitting apparatus as shown in FIG. 3.

### DETAILED DESCRIPTION OF THE PREFERRED EMBODIMENTS

The present invention provides a durable and economical solution to the dilemma facing individuals in the wood processing industry. In particular, a wood translocation and splitting apparatus in accordance with the present invention allows the user to quickly attach the apparatus to an existing and common utility vehicle such as conventional skid steer loaders. Additionally, the apparatus allows for the grasping of wood to be processed, lifting the wood, positioning the wood over a receptacle, splitting the wood and loading the processed wood into the receptacle. Therefore, not only is the user free from having to manually load the apparatus, but they no longer have to pick up the split wood and load them.

An additional unique feature of this invention is the fact that it has very few moving parts and utilizes the remote hydraulics of the utility vehicle. The user does not have to worry about the additional cost and premature obsolescence associated with several moving parts. The translocation and splitting apparatus is lowered and lifted by the existing mechanism of the utility vehicle, removing the need for extensive adaptation of complex pieces of machinery. Moreover, the apparatus is easy to install and remove. The process takes just a few minutes by driving the utility vehicle into engagement with the specified end of the apparatus and connecting the hydraulic hose thereto. Removing the apparatus is just as simple, requiring only the uncoupling of the hydraulic hose and the disengagement of the utility.

A wood translocation and splitting apparatus in accordance with the present invention can be mounted and supported by any suitable utility vehicle which has the functions of mobilizing the wood splitter and supplying appropriate power thereto for powering—supplying power for the operation of the various elements of the present invention. Suitable support vehicles include, but are not limited to tractors, trucks, backhoes, forklifts, cranes, loaders, recreational vehicles, earth-moving vehicles, and the like which may be manufactured by companies such as New Holland®, Bobcat®, Belle®, Thomas®, Case®, Mustang®, Daewoo®, Hydra-Mac®, Rayco®, JCB®, Hyundai®, Scat Trak®, Caterpillar®, John Deere®, Takeuchi®, ASV-positrack®, Gehl®etc. It is particularly desirable for the utility vehicle to have remote hydraulics for carrying out the aforementioned functions. The wood splitting apparatus, however, can be powered by any conventional powering means, including, but not limited to, hydraulic motor or ram, electric motor or internal combustion engine with gears, levers, screw drives, and/or the like.

The wood splitting apparatus of the present invention is preferably mounted in a downward orientation in order to pick up wood workpieces on the ground for splitting the same. The wood workpiece is grasped between a stationary and a pressure-exerting member, which can be made of a wide range of durable materials known in the art. In fact, the stationary member, the pressure-exerting member or both could be wedged blades. The stationary member and the pressure-exerting member are coupled with a support member, wherein the support member is operatively coupled with a utility vehicle. In a preferred embodiment, the pressure-exerting member and the stationary member are configured such that a piece of wood can be lifted from the ground by grasping the piece of wood between the stationary member and the pressure-exerting member.

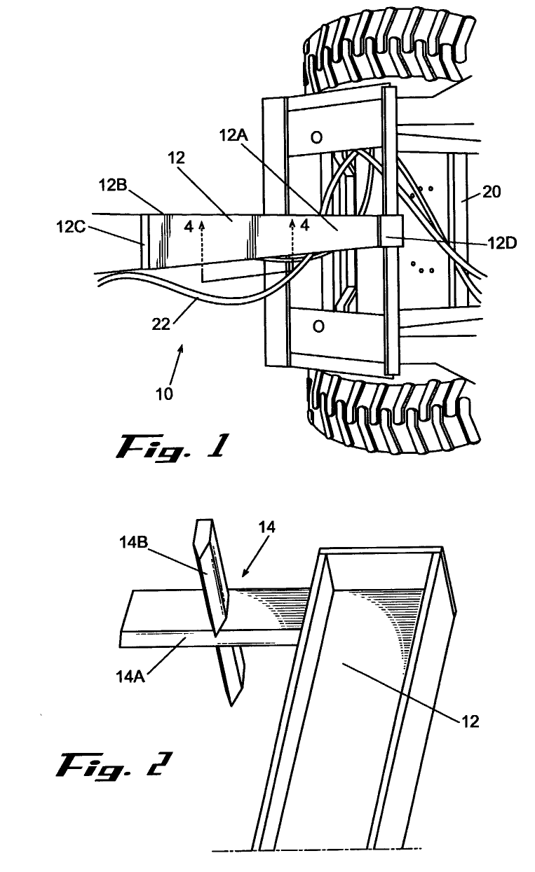

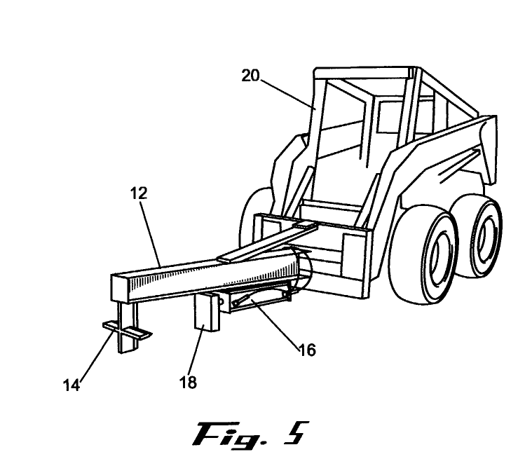

Referring now to the figures, FIGS. 1 and 3-5 show a wood translocation and splitting apparatus 10 in accordance with the present invention. In particular, the apparatus 10 comprises a longitudinally extending support member 12, which is operatively coupled with a utility vehicle 20. The support member has a top 12A and bottom 12B and first 12C and second 12D ends. The apparatus 10 is powered by the remote hydraulics (not shown) of the utility vehicle 20 via the hydraulic hose 22. Coupled with the bottom 12B of the support member 12 are a stationary member 14 and a pressure-exerting member 16.

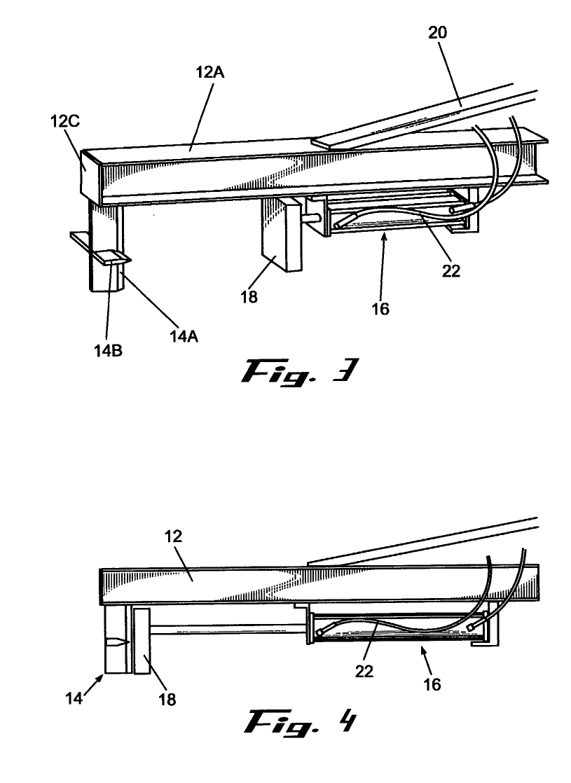

Referring now to FIG. 2, the stationary member 14 comprises a wedge portion for facilitating the splitting action on a wood workpiece. In a preferred embodiment, the stationary member 14 is designed to split wood into four portions, the stationary member 14 has a substantially cross shape formed by vertically and horizontally extending blades, 14A and 14B. It should be noted that the apparatus 10 can be configured to split wood into two portions rather than four, and to that end would not require both vertical blade 14A and horizontal blade 14B. The stationary 14 member can be formed from a wide range of sturdy materials and may be formed as a unitary piece with the support member 12. Additionally, apparatus 10 can be configured so as to process the wood in as many pieces as is desirable.

FIG. 3 shows the pressure-exerting member 16 operatively coupled with the support member 12 and having the power source attached thereto via the hydraulic hose 22. The pressure-exerting member 16 may comprise a hydraulically motivated wedge 18 that moves telescopically to and from the stationary member 14 at the user's discretion. In operation, a wood workpiece can be grasped between the stationary member 14 and the pressure-exerting member 16. The support member 12 can then be lifted under utility vehicle control, and the wood workpiece positioned over a receptacle. In order to split the wood workpiece, the pressure-exerting member 16 is urged telescopically along the support member 12 toward the stationary member 14 so as to narrow the distance between the stationary member 14 and the pressure-exerting member 16. Subject to the pressure, the blades 14A and 14B are wedged into and through the wood workpiece. It should be noted that the pressure exerting-member 16 can be configured so that the wedge 18 has blades like the stationary member 14. Moreover, an alternative apparatus may have two pressure-exerting members rather than having one pressure-exerting member and a stationary member. In any of the above embodiments, the apparatus can be oriented vertically with respect to the ground allowing the wood workpiece to be cut into desired lengths before being split by the apparatus.

In an alternative embodiment, the apparatus 10 can be coupled, preferably with a three-point hitch, to a farm tractor in an inverted orientation so as to serve as a conventional wood splitter. Yet another embodiment of the apparatus, in accordance with the present invention (not shown) provides that the support member is rotated 90° from its standard downward facing orientation so as to provide the pressure-exerting member and either a stationary member or an additional pressure-exerting member facing parallel to the ground when the support member is in the horizontal position. This embodiment allows for additional processing of the wood workpiece, by providing easier access to the wood from the top or the bottom without obstruction from having the support member above the wood.

The present invention may be embodied in other specific forms without deporting from its spirit or essential characteristics. The described embodiments are to be considered in all respects only as illustrative, and not restrictive. The scope of the invention is, therefore, indicated by the appended claims, not the foregoing description. All changes, which come within the meaning and range of equivalency of the claims, are to be embraced within their scope.

What is claimed is:

1. A wood translocation and splitting apparatus for use with a utility vehicle having power controls, the apparatus used to split a wood workpiece having first and second ends, comprising:
a support member;
a stationary member rigidly coupled with the support member the stationary member having at least one edge sufficiently sharp to split a piece of wood;
a pressure-exerting member for exerting force on a first end of a workpiece so as to transition the second end of the workpiece against the edge of the stationary member so as to cause the work piece to be split into more than one section; and
a power supply operatively connecting the pressure-exerting member to a utility vehicle.

2. The apparatus of claim 1, wherein the support member has a top and a bottom and the stationary member and the pressure-exerting member are coupled with the bottom of the support member.

3. The apparatus of claim 2, wherein the utility vehicle is a skid steer loader.

4. The apparatus of claim 2, wherein a piece of wood can be grasped between the stationary and pressure-exerting members.

5. The apparatus of claim 4, wherein the wood can be grasped directly from the ground.

6. The apparatus of claim 1, wherein the support member can be held vertically with respect to the ground.

7. The apparatus of claim 1, wherein the support member can be held horizontally with respect to the ground.

8. An apparatus for use with a utility vehicle, the apparatus used to split a wood workpiece, comprising:
a support member having a top and a bottom;
first and second cutting members movably coupled with the support member, the cutting members each having at least one edge sufficiently sharp to split a piece of wood ; and
a power supply operatively connecting the first and second cutting members to a utility vehicle;
whereby the power supply urges the first and second cutting members toward one another so as to exert pressure to the ends of a workpiece such that the first and second cutting members cause the work piece to be split into more than one section.

9. The apparatus of claim 8, wherein the first and second cutting members are coupled with the bottom of the support member.

10. The apparatus of claim 8, wherein the utility vehicle is a skid steer loader.

11. The apparatus of claim 9, wherein a piece of wood can be grasped between the first and second cutting members.

12. The apparatus of claim 10, wherein the wood can be grasped directly from the ground.

13. The apparatus of claim 8, wherein the support member can be held vertically with respect to the ground.

14. The apparatus of claim 8, wherein the support member can be held horizontally with respect to the ground.

15. An apparatus for use with a utility vehicle, the apparatus used to split a wood workpiece, comprising:
a support member;
a stationary member rigidly coupled with the support member;
a pressure-exerting member, having at least one edge sufficiently sharp to split a piece of wood, the pressure-exerting member capable of exerting force on a first end of a workpiece so as to transition the second end of the workpiece against the stationary member so as to cause the work piece to be split into more than one section; and
a power supply operatively connecting the pressure-exerting member to a utility vehicle.

16. The apparatus of claim 15, wherein the utility vehicle is a skid steer loader.

17. The apparatus of claim 15, wherein a piece of wood can be grasped between the stationary and pressure-exerting members.

18. The apparatus of claim 16, wherein the wood can be grasped directly from the ground.

19. The apparatus of claim 15, wherein the support member can be held vertically with respect to the ground.

20. The apparatus of claim 15, wherein the support member can be held horizontally with respect to the ground.

21. A method, comprising the steps of:
providing an apparatus for splitting wood having a support member, a stationary member rigidly coupled with the support member, the stationary member having at least one edge sufficiently sharp to split a piece of wood, a pressure-exerting member for exerting force on a first end of a workpiece so as to transition the second end of the workpiece against the edge of the stationary member so as to cause the work piece to be split into more than one section, and a power supply operatively connecting the pressure-exerting member to a utility vehicle;
providing a piece of wood to be processed;
maneuvering the utility vehicle so as to orient the stationary member and pressure exerting member adjacent thereto;
urging the stationary member and pressure exerting member to grasp the piece of wood to be processed there between; and
exerting pressure on the wood so as to cause the wood to split.

22. A method of, comprising the steps of:
providing an apparatus for grasping wood having a support member, a stationary member rigidly coupled with the support member, the stationary member having at least one edge sufficiently sharp to split a piece of wood, a pressure-exerting member for exerting force on a first end of a workpiece so as to transition the second end of the workpiece against the edge of the stationary member so as to cause the work piece to be split into more than one section, and a power supply operatively connecting the pressure-exerting member to a utility vehicle;
providing a piece of wood to be moved;
maneuvering the utility vehicle so as to orient the stationary member and pressure exerting member adjacent thereto;
urging the stationary member and pressure exerting member to grasp the piece of wood to be processed there between; and
causing the utility vehicle to lift the wood to be moved; and
moving the wood to the desired location.
